(19) United States
(12) Patent Application Publication
(10) Pub. No.: US 2025/0392824 A1
(43) Pub. Date: Dec. 25, 2025

(54) CONTROL METHOD, ELECTRONIC DEVICE, AND STORAGE MEDIUM

(71) Applicant: Lenovo (Beijing) Limited, Beijing (CN)

(72) Inventors: Zhenyuan ZHAO, Beijing (CN); Zhou YU, Beijing (CN); Hui DENG, Beijing (CN)

(21) Appl. No.: 19/228,713

(22) Filed: Jun. 4, 2025

(30) Foreign Application Priority Data
Jun. 21, 2024 (CN) 202410814754.4

(51) Int. Cl. H04N 23/71; H04N 23/60; H04N 23/617; H04N 23/63

(52) U.S. Cl. CPC H04N 23/71; H04N 23/617; H04N 23/635; H04N 23/64

(57) ABSTRACT

A control method, an electronic device, and a storage medium are provided in the present disclosure. The control method includes obtaining attribute information of a display screen of an electronic device, where the attribute information at least includes configuration data of a first display region of the display screen, and the first display region is a display region corresponding to an under-screen camera of the electronic device; and configuring a drive control parameter of the under-screen camera based on the attribute information, thereby controlling the under-screen camera to complete an image acquisition operation based on the drive control parameter when an image-forming instruction is obtained.

### CROSS-REFERENCE TO RELATED APPLICATION

This application claims the priority of Chinese Patent Application No. 202410814754.4, filed on Jun. 21, 2024, the content of which is incorporated herein by reference in its entirety.

### TECHNICAL FIELD

The present disclosure generally relates to the field of control technology, and, more particularly, relates to a control method, an electronic device, and a storage medium.

### BACKGROUND

Currently, with gradual emergence of electronic devices with under-screen camera technology, there is a trend of evolving to other sizes. In the process of manufacturing under-screen cameras, it is found that the transmittance of the under-screen camera region of the screen not only changes with the change of light wavelength, but also the transmittance data of each screen is different, which may greatly increase the difficulty of adjusting camera image-forming quality. The existing solution is to test the transmittance of the under-screen camera regions of a batch of screens, calculate the means of the transmittance, and use the means to adjust the camera image-forming quality. However, the screen attribute information may vary between different screen pieces, such that some screens with large transmittance deviation may affect the camera image-forming quality when above manner is applied.

### SUMMARY

One aspect of the present disclosure provides a control method. The control method includes obtaining attribute information of a display screen of an electronic device, where the attribute information at least includes configuration data of a first display region of the display screen, and the first display region is a display region corresponding to an under-screen camera of the electronic device; and configuring a drive control parameter of the under-screen camera based on the attribute information, thereby controlling the under-screen camera to complete an image acquisition operation based on the drive control parameter when an image-forming instruction is obtained.

Another aspect of the present disclosure provides an electronic device. The electronic device includes a memory, configured to store a computer program; and one or more processors, configured to, when the computer program is executed, perform a control method. The control method includes obtaining attribute information of a display screen of an electronic device, where the attribute information at least includes configuration data of a first display region of the display screen, and the first display region is a display region corresponding to an under-screen camera of the electronic device; and configuring a drive control parameter of the under-screen camera based on the attribute information, thereby controlling the under-screen camera to complete an image acquisition operation based on the drive control parameter when an image-forming instruction is obtained.

Another aspect of the present disclosure provides a non-transitory computer-readable storage medium containing a computer program that, when being executed, causes one or more processors to perform a control method. The control method includes obtaining attribute information of a display screen of an electronic device, where the attribute information at least includes configuration data of a first display region of the display screen, and the first display region is a display region corresponding to an under-screen camera of the electronic device; and configuring a drive control parameter of the under-screen camera based on the attribute information, thereby controlling the under-screen camera to complete an image acquisition operation based on the drive control parameter when an image-forming instruction is obtained.

Other aspects of the present disclosure may be understood by those skilled in the art in light of the description, the claims, and the drawings of the present disclosure.

### BRIEF DESCRIPTION OF THE DRAWINGS

To more clearly illustrate the technical solutions of embodiments of the present disclosure, accompanying drawings required in embodiments of the present disclosure are briefly described hereinafter. Obviously, accompanying drawings described below may be some embodiments of the present disclosure. Those skilled in the art may obtain other accompanying drawings based on above-mentioned accompanying drawings without creative work.

FIG. 1 illustrates a structural schematic of a display screen according to various embodiments of the present disclosure.

FIG. 2 illustrates another structural schematic of a display screen according to various embodiments of the present disclosure.

FIG. 3 illustrates exemplary transmittance data of different samples according to various embodiments of the present disclosure.

FIG. 4 illustrates a flowchart of a control method according to various embodiments of the present disclosure.

FIG. 5 illustrates a flowchart of obtaining attribute information according to various embodiments of the present disclosure.

FIG. 6 illustrates a flowchart of configuring drive control parameters according to various embodiments of the present disclosure.

FIG. 7 illustrates another flowchart of configuring drive control parameters according to various embodiments of the present disclosure.

FIG. 8 illustrates a flowchart of exemplarily matching an under-screen camera with transmittance of a display region according to various embodiments of the present disclosure.

FIG. 9 illustrates a flowchart of an exemplary verification processing method according to various embodiments of the present disclosure.

FIG. 10 illustrates another flowchart of an exemplary verification processing method according to various embodiments of the present disclosure.

FIG. 11 illustrates another flowchart of exemplarily matching an under-screen camera with transmittance of a display region according to various embodiments of the present disclosure.

FIG. 12 illustrates another flowchart of exemplary configuration of drive control parameters according to various embodiments of the present disclosure.

FIG. 13 illustrates another flowchart of configuring drive control parameters according to various embodiments of the present disclosure.

FIG. 14 illustrates a structural schematic of a control apparatus according to various embodiments of the present disclosure.

FIG. 15 illustrates a structural schematic of an electronic device according to various embodiments of the present disclosure.

### DETAILED DESCRIPTION

The technical solutions of the present disclosure are described in detail below in combination with accompanying drawings in embodiments of the present disclosure. It should be understood that embodiments described in the present disclosure may be merely configured to describe the present disclosure, not to limit the present disclosure. It should also be noted that, for the convenience of description, only the parts related to the present disclosure are shown in accompanying drawings.

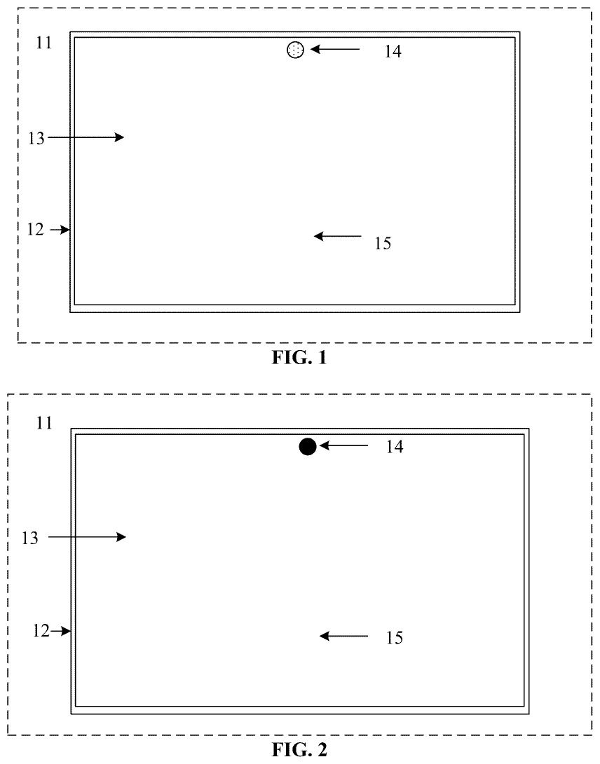

As shown in FIGS. 1-2, a display screen 11 of an electronic device is provided; the display screen 11 may include an organic light-emitting (OLED) display region 12 and an effective display region 13; and the effective display region 13 may include an under-screen camera region 14 and a display region 15 corresponding to no camera. As shown in FIG. 1, when the camera is turned off, the under-screen camera region 14 may display an image, thereby obtaining entire display of the screen, which may avoid incomplete display of the screen such as a hole-punch screen and the like. As shown in FIG. 2, when the camera is turned on, the position of the under-screen camera region 14 of the screen may not display any content, that is, the display at the position of the under-screen camera region 14 may be turned off, which may avoid the display light of the screen affecting the image-forming quality of the camera. At this point, the camera may perform image acquisition operations by receiving light passing through the under-screen camera region 14 in the display screen 11. The image-forming light of the camera may need to pass through the under-screen camera region 14 of the display screen and then be incident on a photosensitive device of the camera; and the organic light-emitting display screen is a display screen with a multi-layer structure. Therefore, when using the under-screen camera screen for camera image-forming design, the following problems may likely occur. 1) In the under-screen camera regions 14, the stacked layer thicknesses of the organic light-emitting displays may not be exactly same, such that the transmittances of different screen samples may be different for same wavelength of light, and some transmittance differences may be relatively large, which may be difficult to adjust the optical performance of the cameras. 2) For light with the wavelength of 615 nm, the transmittances of different screen samples may vary greatly, which may range from 14% to 17%; and in response to that the mean transmittance value is used as a camera image-forming algorithm, some extreme display screens may have extremely poor image-forming quality due to transmittance deviation (e.g., color deviation or cast). 3) For the light with wavelengths of 525 nm and 465 nm, the transmittances may also have deviation. In more extreme cases, exemplarily, for some extreme screen samples, the transmittance at 615 nm may be much larger than the average transmittance, while the transmittance at 525 nm may be much smaller than the average transmittance. At this point, when the camera performs image-forming operations, the light content of 525 nm wavelength may be insufficient, while the light content of 615 nm wavelength may be in excess. in response to that the average algorithm is used, the camera may have serious color deviation problems, resulting in poor image-forming quality.

Exemplarily, the red, green and blue wavelength transmittance data of different display screens are shown in FIG. 3. As shown in FIG. 3, the transmittance information of different display screens (1-15) may be different to solve the problem of poor camera image-forming quality caused by different transmittances of different display screens.

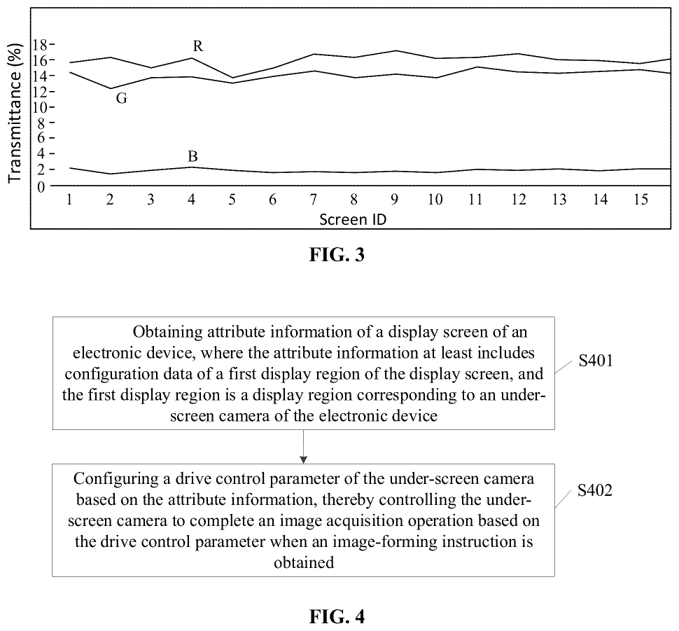

Embodiments of the present disclosure provide a control method, which may be implemented by the electronic device. As shown in FIG. 4, the control method may include following exemplary steps.

At S401, attribute information of the display screen of the electronic device may be obtained. The attribute information may at least include configuration data of the first display region of the display screen; and the first display region may be the display region corresponding to the under-screen camera of the electronic device.

In embodiments of the present disclosure, the electronic device may be an electronic device with a control function, including a tablet computer, a laptop computer, a handheld computer, a mobile phone, a personal digital assistant (PDA), a desktop computer, an all-in-one computer and/or the like, which may not be limited in the present disclosure.

In embodiments of the present disclosure, the attribute information of the display screen may be the information representing the characteristics of the display screen, which may affect the image-forming quality of the under-screen camera. Exemplarily, the attribute information may include a model, a manufacturer, a manufacturing material, a type, a thickness, a display layout, a pixel density, and a transmittance of the display screen, and the attribute information may at least include the configuration data of the first display region in the display screen. Exemplarily, the configuration data may be a shape, a region size, a pixel density, and a transmittance of the first display region.

Exemplarily, as shown in FIGS. 1-2, the first display region of the display screen may correspond to the under-screen camera region 14 of the electronic device 11.

In embodiments of the present disclosure, the timing when the electronic device obtains the attribute information of the display screen of the electronic device may be the first time the electronic device is turned on, or the first time the under-screen camera of the electronic device is called. The acquisition timing may be set according to actual situation and application requirement, which may not be limited in the present disclosure.

At S402, the drive control parameter of the under-screen camera may be configured based on the attribute information, thereby controlling the under-screen camera to complete the image acquisition operation based on the drive control parameter when the image-forming instruction is obtained.

In embodiments of the present disclosure, the electronic device may configure the drive control parameter of the under-screen camera based on the attribute information, where the drive control parameter may be the control parameter for driving the under-screen camera of the electronic device to complete the image acquisition operation. Exemplarily, the drive control parameter may include a compensation parameter calculated based on the screen transmittance and the like, extended exposure time, brightness, contrast, a color temperature, saturation, an acquisition frame rate during video recording, and/or the like.

In embodiments of the present disclosure, the timing for configuring the under-screen camera of the electronic device based on the attribute information of the display screen may be the first time the electronic device is turned on, or the first time the under-screen camera is called. The configuration timing may be set according to actual situation and application requirement, which may not be limited in the present disclosure. In embodiments of the present disclosure, the image-forming instruction may be an image preview instruction, an image acquisition instruction, or a video recording instruction; and obviously may also be other instructions that require image acquisition operations. The image-forming instruction may be set according to actual situation and application requirement, which may not be limited in the present disclosure.

Exemplarily, the image acquisition operation may be an operation such as taking a photo, previewing, recording a video or the like.

Exemplarily, the implementation manner of configuring the drive control parameter of the under-screen camera based on the attribute information may be configuring a drive control algorithm used by the camera and corresponding control parameters, adjusting default drive control parameter directly using a set of parameter values, rewriting a new set of control parameters, rewriting a new set of control logics, or the like.

Exemplarily, the drive control parameter may be the acquisition frame rate during video recording, and the image-forming instruction may be the video recording instruction. At this point, the image may be acquired by reducing the frame rate during video recording which may improve the image quality.

Exemplarily, when the electronic device is performing image acquisition, the electronic device may obtain the transmittance data of the first display region in the display screen, including a red transmittance percentage, a green transmittance percentage, a red and green transmittance deviation percentage. At this point, the electronic device may configure the drive control parameters of the under-screen camera based on the transmittance data, including exposure time, field of view, chromaticity, brightness, saturation and/or the like, such that the image acquired by the under-screen camera based on the drive control parameters may be more consistent with real image.

Compared with the solution that the average transmittance of the under-screen camera region is used to adjust the image-forming quality of the camera, which may result in poor image-forming quality, in the present disclosure, the attribute information of the display screen may be obtained to configure the drive control parameter, such that the image acquisition operation may be completed based on the drive control parameter during the image-forming process, and the display screen and the camera drive control parameter may be accurately matched with each other, thereby improving the image-forming quality.

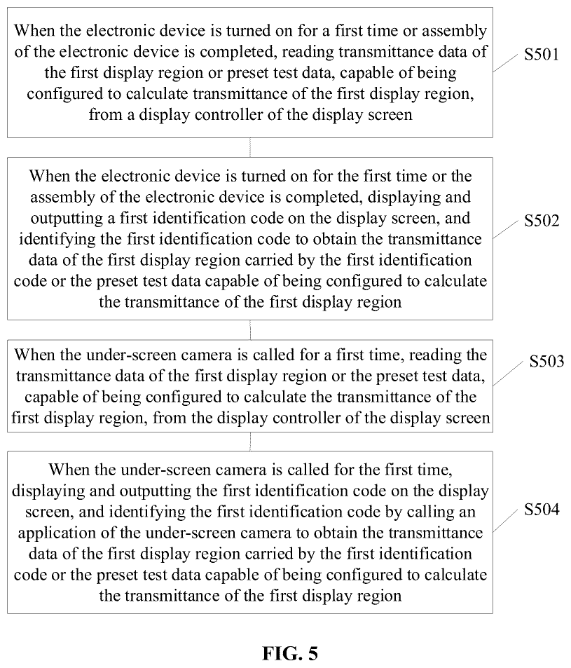

In some embodiments, when the electronic device executes above-mentioned exemplary step S401, as shown in FIG. 5, the electronic device may also execute at least one of following exemplary steps S501 to S504.

At S501, when the electronic device is turned on for the first time or assembly of the electronic device is completed, the electronic device may read the transmittance data of the first display region from a display controller of the display screen or the preset test data capable of being configured to calculate the transmittance of the first display region.

In embodiments of the present disclosure, the first turn-on of the electronic device may be the first turn-on of the electronic device for usage; the assembly completion of the electronic device may be the process of assembling the display screen, the camera, the motherboard and other components into the electronic device for testing, or the completion of production for shipment.

Exemplarily, the display controller may be a driver (TCON) chip, Scalar or other integrated chip (IC) of the display screen, or other controller that may store data corresponding to the display screen. The display controller may be set according to actual needs and application scenarios, which may not be limited in the present disclosure.

In embodiments of the present disclosure, the electronic device may read the transmittance data of the first display region from the display controller of the display screen or the preset test data capable of being configured to calculate the transmittance of the first display region. Exemplarily, the preset test data may at least include a pixel density, a screen thickness, a display region size, and a shape of the first display region; and the transmittance data may be a red transmittance, a green transmittance, and a deviation of the red transmittance and the green transmittance.

Exemplarily, when the electronic device is turned on for the first time, the electronic device may directly obtain the transmittance data of the first display region from the driver chip of the display screen, including the red transmittance (A %), the green transmittance (B %), the deviation of the red transmittance and the green transmittance (C %); or in response to that the display screen is a liquid crystal display screen, when the electronic device is turned on for the first time, the electronic device may directly obtain the preset front light source brightness of the display screen, the attribute configuration information of the display screen (the manufacturer, the model, the material, the thickness, the number of layers, and the like), the number of liquid crystal molecules and the pixel size from the driver chip of the display screen. Above information related to the transmittance of the display screen may be configured to calculate the preset test data of the transmittance of the first display region.

At S502, when the electronic device is turned on for the first time or assembly of the electronic device is completed, the first identification code may be outputted on the display screen, and the first identification code may be identified to obtain the transmittance data of the first display region carried by the first identification code or the preset test data capable of being configured to calculate the transmittance of the first display region.

In embodiments of the present disclosure, the electronic device may associate the transmittance data of the display screen or the preset test data capable of being configured to calculate the transmittance of the first display region with the first identification code corresponding to the display screen; or store above-mentioned data in the form of the first identification code in the display controller, the embedded controller (EC), or the memory SSD/HDD of the electronic device. When the electronic device is first turned on or assembly of the electronic device is completed, the first identification code may be displayed and outputted on the display screen, such that the first identification code may be identified to obtain the transmittance data of the first display region, which is associated with or characterized by the first identification code, or the preset test data capable of being configured to calculate the transmittance of the first display region. The preset test data and the transmittance data may be consistent with corresponding data in above-mentioned exemplary step S501, which may not be described in detail herein.

In embodiments of the present disclosure, the implementation manner of the electronic device identifying the first identification code may be a screen identifying manner, for example, identifying the first identification code by a camera application, or by other applications capable of calling the camera to identify displayed first identification code. For example, the first identification code may be a two-dimensional QR (quick response) code, a one-dimensional barcode, or other recognizable code.

Exemplarily, when the electronic device is turned on, the electronic device may call the display controller of the electronic device to display the first identification code of the display screen stored in the memory on the display screen and may then call the virtual camera to identify the first identification code displayed on the display screen to obtain corresponding transmittance data or preset test data.

At S503, when the under-screen camera is called for the first time, the transmittance data of the first display region or the preset test data capable of being configured to calculate the transmittance of the first display region may be read from the display controller of the display screen.

In embodiments of the present disclosure, the attribute information of the display screen of the electronic device may also be obtained by reading the transmittance data of the first display region or the preset test data, which is capable of being configured to calculate the transmittance of the first display region, from the display controller of the display screen when the under-screen camera is called for the first time. The display controller, the transmittance data and the preset test data may be consistent with corresponding data in above-mentioned exemplary steps, which may not be described in detail herein. Exemplarily, the under-screen camera called for the first time may be that the under-screen camera is called by the driver of the camera application; or called by the video call process of other applications such as WeChat, teams and/or the like; or called when there is an image acquisition need when using above-mentioned applications.

At S504, when the under-screen camera is called for the first time, the first identification code may be displayed and outputted on the display screen, and the first identification code may be identified by using and calling the application of the under-screen camera to obtain the transmittance data of the first display region carried by the first identification code or the preset test data capable of being configured to calculate the transmittance of the first display region.

In embodiments of the present disclosure, when the under-screen camera is called for the first time, the electronic device may output the first identification code on the display screen, and then use and call the application of the under-screen camera to identify the first identification code, thereby obtaining the transmittance data of the first display region carried by the first identification code or the preset test data capable of being configured to calculate the transmittance of the first display region. The transmittance data and the preset test data may be consistent with corresponding data in above-mentioned exemplary step 501, which may not be described in detail herein. Exemplarily, the electronic device may use the driver of the under-screen camera or other cameras, for example, the rear camera or the virtual camera, to identify the display image of the first identification code.

In above-mentioned embodiments of the present disclosure, the attribute information, including the transmittance data or the preset test data capable of being configured to calculate the transmittance of the first display region, may be stored in the electronic device in advance; and different times and different manners may be configured to enable the electronic device to directly obtain corresponding attribute information, thereby improving the flexibility and efficiency of obtaining the attribute information of the display screen.

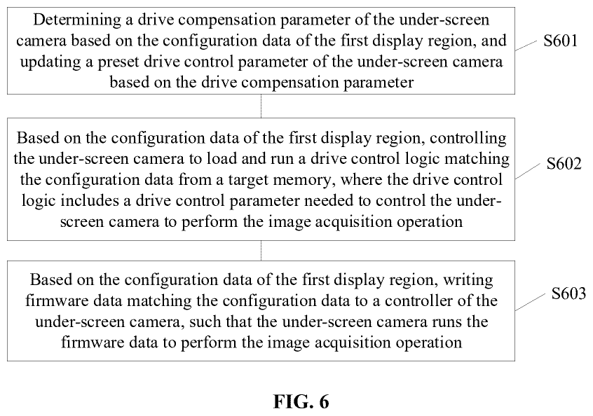

In some embodiments, when the electronic device executes the “configuring the drive control parameter of the under-screen camera based on the attribute information” in above-mentioned exemplary step S402, as shown in FIG. 6, at least one of following exemplary steps S601 to S603 may be included.

At S601, the drive compensation parameter of the under-screen camera may be determined based on the configuration data of the first display region, and the preset drive control parameter of the under-screen camera may be updated based on the drive compensation parameter.

In embodiments of the present disclosure, the electronic device may be pre-set with the drive control parameter of the display screen. After the electronic device determines the drive compensation parameter of the under-screen camera based on the configuration data of the first display region actually obtained, the drive compensation parameter may be configured to update the preset drive control parameter of the under-screen camera, such that the under-screen camera may be controlled to complete the image acquisition operation based on updated drive control parameter when the image-forming instruction is obtained, thereby ensuring the quality of image acquisition. Herein, the configuration manner corresponding to above-mentioned exemplary step S402 may be that a set of parameter values may be configured to directly adjust default drive control parameter, and adjusted parameter may be brightness gain, RGB gain or exposure time.

Exemplarily, the preset drive control parameters of the under-screen camera may be average brightness value, average exposure time value, average saturation value and the like corresponding to the camera under such type of display screen, which may be determined based on the configuration data such as the manufacturer, the model, and the manufacturing material of the display screen. However, due to the differences between different display screens, the electronic device may determine the drive compensation parameter, including brightness gain, saturation or exposure time, corresponding to the under-screen camera based on actual configuration data of the display screen, and adjust the preset drive control parameter using determined brightness gain, saturation or exposure time, such that adjusted drive control parameter may be more matched with the under-screen camera, thereby improving the image acquisition accuracy.

At S602, based on the configuration data of the first display region, the under-screen camera may be controlled to load and run the drive control logic matching the configuration data from a target memory, and the drive control logic may include the drive control parameter needed to control the under-screen camera to perform image acquisition operations.

In embodiments of the present disclosure, based on the configuration data of the display region, the electronic device may control the under-screen camera to load and run the drive control logic matching the configuration data from the target memory. Exemplarily, the target memory may be the memory of the digital signal processing technology (DSP) of the camera, or the memory of the integrated circuit (IC) of the display screen.

In embodiments of the present disclosure, the drive control logic may include the drive control parameter needed to control the under-screen camera to perform image acquisition operations. The target memory may store a mapping relationship table between multiple groups of configuration data and drive control logics, and the electronic device may load and run corresponding control logic based on the configuration data to complete the configuration of the camera. Herein, the configuration manner corresponding to above-mentioned exemplary step S402 may be configuring the drive control algorithm used by the camera, and corresponding control parameters.

As shown in Table 1, multiple groups of configuration data, including the mapping relationships between transmittance data and the drive control logics (L1, L2, L3, L4, L5, L6, L7, L8 and L9 may be respectively configured to represent the label of a group of configuration data) may be displayed, where A, B, C, . . . , and I may represent control logics, respectively.

TABLE 1

| | | | Deviation | |
|---|---|---|---|---|
| | | | between red | |
| | | | transmittance | |
| | | Green | and green | Control |
| | Red transmittance | transmittance | transmittance | logic |
| L1 | a %~(a + 1)% | b %~(b + 1)% | <1% | A |
| L2 | a %~(a + 1)% | (b + 1)%~(b + 2)% | <1%, <2% | B |
| L3 | a %~(a + 1)% | (b + 2)%~(b + 3)% | >2%, <3% | C |
| L4 | (a + 1)%~(a + 2)% | b %~(b + 1)% | >1%, <2% | D |
| L5 | (a + 1)%~(a + 2)% | (b + 1)%~(b + 2)% | <1% | E |
| L6 | (a + 1)%~(a + 2)% | (b + 2)%~(b + 3)% | >1%, <2% | F |
| L7 | (a + 2)%~(a + 3)% | b %~(b + 1)% | >2%, <3% | G |
| L8 | (a + 2)%~(a + 3)% | (b + 1)%~(b + 2)% | >1%, <2% | H |
| L9 | (a + 2)%~(a + 3)% | (b + 2)%~(b + 3)% | <1% | I |

Exemplarily, the configuration data obtained by the electronic device may be the transmittance data of the display screen, including the red transmittance A %, the green transmittance B %, the deviation of the red transmittance and the green transmittance C %; and based on the transmittance data, the electronic device may find which group that the red transmittance A %, the green transmittance B %, and the deviation of the red transmittance and the green transmittance C % belong to, from the mapping relationship table (see Table 1) stored in the memory of the display screen. It is assumed that the red transmittance A %, the green transmittance B %, and the deviation of the red transmittance and the green transmittance C % belong to the group L1, the drive control logic matching the acquired transmittance data may be A, and furthermore the A drive control logic may be loaded and run to complete the data acquisition of the under-screen camera.

Exemplarily, it is assumed that the drive control logic is configured to adjust the color saturation, brightness, contrast and the like in the drive control parameters to certain values, the values of the color saturation, brightness, and contrast in the drive control logics A-I may be different to correspond to different groups.

At S603, based on the configuration data of the first display region, firmware data matching the configuration data may be written to the controller of the under-screen camera, such that the under-screen camera may run the firmware data to perform image acquisition operations.

In embodiments of the present disclosure, the controller may be a controller configured to drive the camera to perform image acquisition operations. The controller may be an IC capable of controlling the operations of the camera, including a central processing unit (CPU), a management controller (MCU), an embedded controller (EC) or the like. The firmware data may be the drive control parameters needed to control the under-screen camera to perform image acquisition operations. Herein, the configuration manner corresponding to above-mentioned exemplary step S402 may be re-writing a new set of control parameters, writing a new set of control logics or the like.

Exemplarily, the electronic device may determine a matched driver (control logic) of the under-screen camera based on the configuration data of the first display region and write the driver into the controller of the under-screen camera, such that the under-screen camera may run the driver to perform image acquisition operations. Obviously, determined firmware data may only include the control parameters in the driver, and the control parameters in the driver may be rewritten into the controller of the under-screen camera, such that the under-screen camera may run the driver to perform image acquisition operations. The type of the controller may be an erasable programmable read-only memory (EPROM) or an electrically erasable programmable read-only memory (EEPROM).

In above-mentioned embodiments of the present disclosure, corresponding drive control parameters may be configured for the configuration data of the first display region by setting different configuration drive control parameters, which may improve the image acquisition quality when performing image acquisition operations based on the drive control parameters.

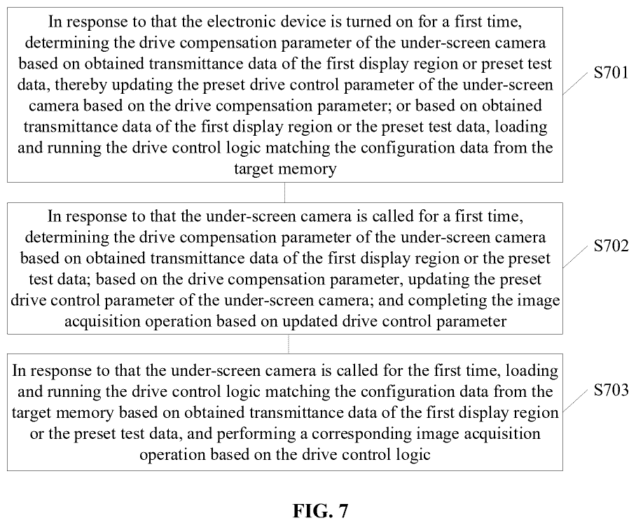

In some embodiments, when the electronic device executes the “configuring the drive control parameter of the under-screen camera based on the attribute information” in above-mentioned exemplary step S402, as shown in FIG. 7, at least one of following exemplary steps S701 to S703 may be included.

At S701, in response to that the electronic device is turned on for the first time, the drive compensation parameter of the under-screen camera may be determined based on obtained transmittance data of the first display region or the preset test data, thereby updating the preset drive control parameter of the under-screen camera based on the drive compensation parameter; or the matched drive control logic from the target memory may be loaded and run based on obtained transmittance data of the first display region or the preset test data.

Exemplarily, after the electronic device is turned on for the first time, the transmittance data of the first display region may be obtained from the memory corresponding to the display screen; based on obtained transmittance data, corresponding drive control logic may be matched and loaded from the multiple groups of configuration data shown in Table 1; and finally, it determines whether there is an image acquisition need at this point. In response to that there is no image acquisition need, the configuration process may be terminated, such that the configuration process may be used when there is a subsequent image acquisition need. In response to that there is an image acquisition need, the electronic device may directly run matched corresponding drive control logic.

At S702, in response to that the under-screen camera is called for the first time, the drive compensation parameter of the under-screen camera may be determined based on the obtained transmittance data of the first display region or the preset test data, the preset drive control parameter of the under-screen camera may be updated based on the drive compensation parameter, and the image acquisition operation may be completed based on updated drive control parameter.

Exemplarily, when the user of the electronic device needs to make a video call, the under-screen camera may be called. At this point, firstly, it determines whether current under-screen camera is called for the first time; in response to that current under-screen camera is called for the first time, the preset test data of the first display region, including the front light source brightness, the number of liquid crystal molecules and the pixel size, may be obtained from the memory of the display screen; the transmittance data may be determined based on the preset test data, including the front light source brightness, the number of liquid crystal molecules and the pixel size; the drive compensation parameter may be determined based on the transmittance data; and the under-screen camera may be used for the video call after the drive control parameter is updated.

At S703, in response to that the under-screen camera is called for the first time, the matching drive control logic may be loaded and run from the target memory based on obtained transmittance data of the first display region or the preset test data, and corresponding image acquisition operation may be performed based on the drive control logic.

Exemplarily, when the user of the electronic device needs to record a video, the under-screen camera may be called; in response to determining that the under-screen camera is called for the first time, the transmittance data of the first display region may be obtained from the memory of the display screen; corresponding drive control logic may be matched from the multiple groups of configuration data stored in the memory as shown in Table 1; and the under-screen camera may be configured to perform video recording based on the drive control logic.

In above-mentioned embodiments of the present disclosure, different configuration drive control parameters may be set between performing image acquisition operations, such that after receiving the image-forming instruction, the image acquisition operation may be performed based on the drive control parameter, which may make the image quality obtained by the image acquisition higher.

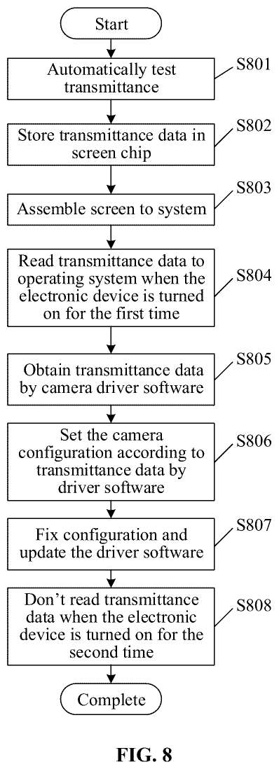

As shown in FIG. 8, FIG. 8 illustrates a flowchart of matching the under-screen camera with the transmittance of the display region; and the flowchart may include following exemplary steps S801 to S808.

At S801, the transmittance may be automatically tested.

In one embodiment, after the display screen is manufactured, the transmittance data of the under-screen camera may be automatically tested.

At S802, the transmittance data may be stored in a screen chip.

In one embodiment, the transmittance data of the under-screen camera obtained by the automatic test may be written to the Tcon chip (display controller) of the display screen through read-write software or other display controllers, which may refer to the description in above-mentioned exemplary step S501.

At S803, the screen may be assembled to the system.

In one embodiment, the display screen may be assembled to the system, which may refer to the assembly completion mentioned in above-mentioned steps.

At S804, the transmittance data may be read to the operating system when the electronic device (machine) is turned on for the first time.

In one embodiment, when the assembled electronic device is turned on for the first time, the transmittance data stored in the screen chip may be read to the operating system (OS) through the screen interface (e.g., a bidirectional transmission auxiliary channel (AUX channel) of the display interface (eDP interface), or a dedicated channel including inter-integrated circuit (I2C)/serial peripheral interface (SPI)).

At S805, the camera driver software may obtain the transmittance data.

In one embodiment, the camera driver software (firmware) may obtain the transmittance data of the display screen through the system.

At S806, the driver software may set the camera configuration according to the transmittance data.

In one embodiment, the driver software may use an algorithm to match the camera algorithm data and fix the parameters (drive control parameters) into the drive algorithm, and the camera drive algorithm may be updated and fully matched with the camera algorithm.

At S807, the configuration may be fixed, and the driver software may be updated.

In one embodiment, after the matching is completed, the drive algorithm may be fixed and automatically exited, and no matching may be needed subsequently.

At S808, the transmittance data may not be read to the operating system when the electronic device (machine) is turned on for the second time.

In one embodiment, after the electronic device is turned on for the second time, the transmittance data may be no longer read.

In above-mentioned embodiments, the transmittance data of the under-screen camera region of each screen may be measured, and above data information may be stored. When assembling the screen to the system, the measured transmittance data may be called. Next, different camera driving solutions may be matched with different transmittance data of the screens, which may achieve accurate matching between the transmittance of the screen and the camera driving, such that the camera image-forming consistency may be desirable.

In such way, according to the transmittance characteristics of the under-screen camera region (that is, the transmittance data between each piece may be different), accurate matching between the screen transmittance and the camera algorithm may be achieved, which may improve the image-forming quality of the under-screen camera. The transmittance data of the screen is matched with the algorithm of the camera, the algorithm of the camera may accurately perform parameter adjustment according to the transmittance data of corresponding screen, such that the image-forming quality of each camera may not vary greatly with transmittance difference, and the camera image-forming consistency may be desirable.

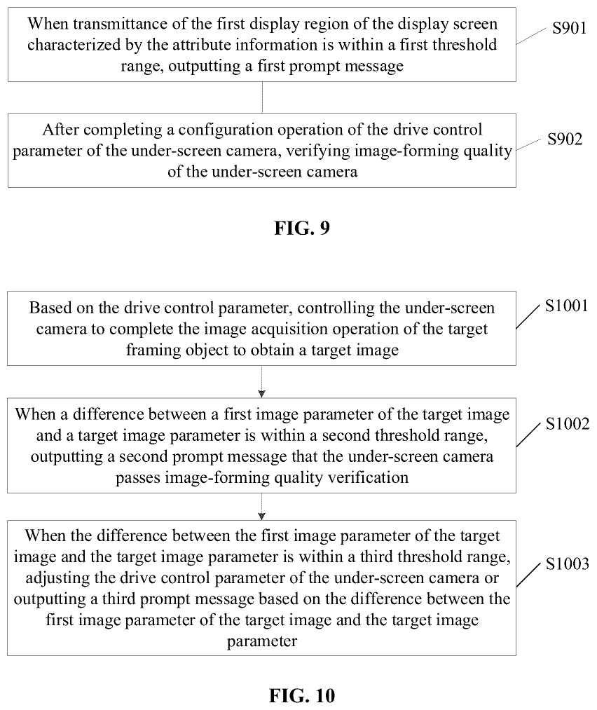

In some embodiments, as shown in FIG. 9, the electronic device may further perform at least one of following exemplary steps S901 and S902.

At S901, a first prompt message may be outputted when the attribute information characterizes that the transmittance of the first display region of the display screen is within the first threshold range.

In embodiments of the present disclosure, in response to that the attribute information of the display screen of the electronic device characterizes that the transmittance of the first display region of the display screen is within the first threshold range, the first prompt message may be outputted. The first threshold range may be a preset transmittance range of the first display region. The transmittance of the first display region being within the first threshold range may indicate that the transmittance of the first display region may cause the camera to be unable to complete the image-forming of the under-screen camera; that is, the image-forming condition of the under-screen camera may not be satisfied.

In embodiments of the present disclosure, the first prompt message may be a prompt message characterizing that the first display region may not be compatible with the specification of the under-screen camera. Exemplarily, the first prompt message may be a prompt message of replacing the display screen or the under-screen camera, or a prompt message that the electronic device is defective or unqualified.

In embodiments of the present disclosure, the technical solution that the drive control parameters are configured for the under-screen camera based on the attribute information of the display screen is provided in embodiments of the present disclosure, such that the first threshold range herein may be suitably set to be relatively small. That is, the technical solution that the drive control parameters are configured for the under-screen camera based on the attribute information of the display screen is provided in embodiments of the present disclosure, which may improve the transmittance yield of the display screen.

At S902, after completing the configuration operation of the drive control parameter of the under-screen camera, the image-forming quality of the under-screen camera may be verified.

In embodiments of the present disclosure, after completing the configuration operation of the drive control parameter of the under-screen camera, the electronic device may verify the image-forming quality of the under-screen camera, thereby verifying whether the image-forming quality satisfies the requirement. Exemplarily, the verification may be performed on the image parameters such as the color accuracy, brightness, resolution, exposure time of the image-formation, and/or the like.

In above-mentioned embodiments, the present disclosure may configure two manners. One manner may be to eliminate the display screen that the transmittance of the first display region is within the first threshold range before configuring the drive control parameter; and another manner may be to verify the image-forming quality of the under-screen camera after configuring the drive control parameter, which may provide double check to improve the image-forming quality of the camera.

In some embodiments, when the electronic device executes above-mentioned exemplary step S902, as shown in FIG. 10, following exemplary steps S1001 to S1003 may be further included.

At S1001, the under-screen camera may be controlled to complete the image acquisition operation of the target framing object based on the drive control parameter to obtain a target image.

In embodiments of the present disclosure, after the electronic device configures the drive control parameter for the under-screen camera, the electronic device may control the under-screen camera to perform the image acquisition operation on the target framing object based on the drive control parameter to obtain the target image. Exemplarily, the target framing object may be an image of a certain color or a certain object, such as a standard color picture taken; and the parameters including color accuracy and the like of the camera may be determined based on the difference therebetween.

At S1002, when the difference (difference data) between a first image parameter of the target image and a target image parameter is within the second threshold range, the second prompt message that the under-screen camera has passed the image-forming quality verification may be outputted.

In embodiments of the present disclosure, in response to that the difference (difference data) between the first image parameter of the target image and the target image parameter is within the second threshold range, it indicates that the under-screen camera has passed the image-forming quality verification, and the second prompt message may be outputted at this point. The second prompt message may characterize that the under-screen camera has passed the image-forming quality verification; that is, the difference between the first image parameter of acquired target image and the target image parameter may be relatively small, or the difference between the target image and the standard image may be relatively small. Obviously, in response to that higher image-forming quality is required, the second threshold range may be set to be relatively small; and in response to that lower image-forming quality is required, the second threshold range may also be set to be relatively large. The second threshold range may be set based on actual needs and application scenarios, which may not be limited in the present disclosure.

Exemplarily, the target image parameter may be an image parameter of the standard image, or an appearance parameter of the target framing object (standard object).

Exemplarily, in response to that the second threshold range is the brightness threshold range of 0 cd/m² to 10 cd/m², the brightness value included in the first image parameter is 20 cd/m², and the brightness value included in the target image parameter is 25 cd/m², it may characterize that the difference (e.g., difference data) between the first image parameter and the target image parameter may be the difference brightness value of 5 cd/m² which is in the brightness threshold range of 0 cd/m² to 10 cd/m², such that the under-screen camera may pass the image-forming quality verification.

At S1003, when the difference (e.g., difference data) between the first image parameter of the target image and the target image parameter is within the third threshold range, the drive control parameter of the under-screen camera may be adjusted based on the difference (e.g., difference data); or the third prompt message may be outputted.

In embodiments of the present disclosure, in response to that the difference data between the first image parameter of the target image and the target image parameter is within the third threshold range, it may indicate that the under-screen camera has not passed the image-forming quality verification, and the third prompt message may be outputted at this point; or the drive control parameter of the under-screen camera may be adjusted based on the difference data. The third prompt message may characterize that the under-screen camera has passed the image-forming quality verification. That is, the difference between the first image parameter of the captured target image and the target image parameter may be relatively large, or the difference between the target image and the standard image may be relatively large. The third threshold range may be set based on actual needs and application scenarios, which may not be limited in the present disclosure.

Exemplarily, in response to that the third threshold range is the brightness threshold range of 10 cd/m² to 50 cd/m², the brightness value included in the first image parameter is 20 cd/m², and the brightness value included in the target image parameter is 35 cd/m², it may characterize that the difference (e.g., difference data) between the first image parameter and the target image parameter may be the difference brightness value of 15 cd/m² which is in the brightness threshold range of 10 cd/m² to 50 cd/m², such that the under-screen camera may fail to pass the image-forming quality verification.

In above-mentioned embodiments of the present disclosure, the image-forming quality of the image acquisition operation may be verified to ensure that configured drive control parameter is adapted to the first display region of the display screen, thereby improving the image-forming quality.

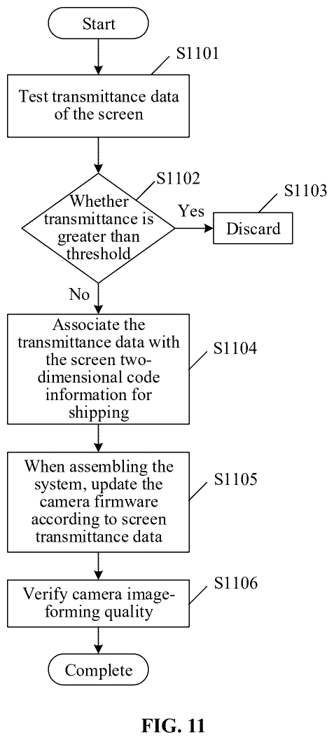

As shown in FIG. 11, FIG. 11 illustrates another flowchart of exemplarily matching the under-screen camera with the transmittance of the display region according to various embodiments of the present disclosure; and the flowchart may include following exemplary steps S1101 to S1106.

At S1101, the transmittance data of the screen may be tested.

In one embodiment, after the display screens are manufactured, the electronic device may perform a transmittance test on the under-screen camera region (first display region) of the display screens piece by piece to remove the screen with extreme transmittance, which may refer to the description of above-mentioned exemplary step S901.

At S1102, it determines whether the transmittance is greater than a threshold.

In one embodiment, the electronic device may set a threshold (the first threshold range) for the transmittance of the under-screen camera region and determine whether the transmittance of the under-screen camera region is greater than the threshold. In response to that the transmittance of the under-screen camera region is greater than the threshold, execute exemplary step S1103; and in response to that the transmittance of the under-screen camera region is not greater than the threshold, execute exemplary step S1104.

At S1103, the display screen with the transmittance greater than the threshold in the under-screen camera region may be discarded.

In one embodiment, the display screen with the transmittance greater than the threshold in the under-screen camera region may be discarded or the under-screen camera may be replaced.

At S1104, the transmittance data may be associated with the screen two-dimensional code information for shipping.

In one embodiment, the electronic device may associate retained transmittance data of the display screens with the two-dimensional code information of the display screens; divide the display screens into multiple groups as shown in Table 1 according to different transmittance data (Table 1 exemplarily lists an application example of grouping, and obviously, different groups may be obtained according to different classification manners); and match the camera algorithms A, B, C, D, E, F, G, H, I and the like (the control logics) for different transmittance groups.

At S1105, when assembling the system, the camera firmware may be updated according to the screen transmittance data.

In one embodiment, when assembling the system, the electronic device may obtain the screen transmittance data and grouping information by scanning the two-dimensional code information outputted by the screens, respectively update the camera algorithms (the drive control parameters) corresponding to the cameras for different group of screens and assemble the screens into the system. For the system at this point, the camera algorithm (the drive control parameter) and the screen transmittance data (attribute information) may be matched to each other.

At S1106, camera image-forming quality may be confirmed.

In one embodiment, the electronic device may verify the image-forming quality of the under-screen camera, which may refer to the description of above-mentioned exemplary steps S901 to S903.

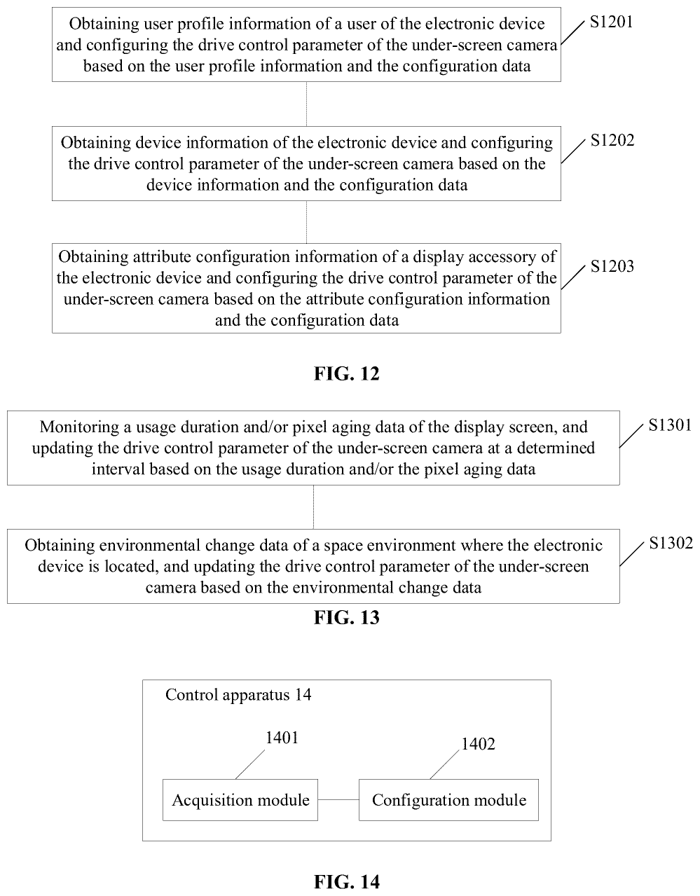

In some embodiments, as shown in FIG. 12, when the electronic device executes the “configuring the drive control parameter of the under-screen camera based on the attribute information” in above-mentioned exemplary step S402, at least one of following exemplary steps S1201 to S1203 may be included.

At S1201, user profile information of the user of the electronic device may be obtained, and the drive control parameter of the under-screen camera may be configured based on the user profile information and the configuration data.

In embodiments of the present disclosure, on the basis of obtaining the attribute information, the user profile information of the user of the electronic device may also be obtained, and the drive control parameter of the under-screen camera may be configured by combining the user profile information and the configuration data included in the attribute information. In such way, when the user's usage habits or preferences are considered, configured drive control parameter may be more in line with the user's needs.

Exemplarily, in response to that during the operating process, the user is accustomed to increasing the color saturation and contrast when collecting images, the color saturation and contrast in the drive control parameter may be increased when the drive control parameter of the under-screen camera is configured.

At S1202, the device information of the electronic device may be obtained, and the drive control parameter of the under-screen camera may be obtained based on the device information and configuration data.

In embodiments of the present disclosure, on the basis of obtaining the attribute information, the device information of the electronic device may also be obtained, and the drive control parameter of the under-screen camera may be configured by combining the device information and the configuration data included in the attribute information. Exemplarily, the device information may include a device state, a device type, a device usage scenario, and a location (fixed or movable). Herein, it mainly considers that the drive control parameters configured for the mobile phone, the notebook computer and the surveillance camera fixed at a certain location for image acquisition may be different. Combined with the device information, the under-screen camera in different usage scenarios may be matched.

Exemplarily, in response to that the usage scenario of the electronic device is to monitor surrounding environment indoors, the change frequency in surrounding environment of the electronic device may need to be considered at this point. In response to that the surrounding environment is relatively stable, the acquisition frame rate during the monitoring video recording process in the configured drive control parameter should be correspondingly reduced at this point. In response to that the surrounding environment is relatively complex, the acquisition frame rate during the monitoring video recording process in the configured drive control parameter should be correspondingly increased at this point.

At S1203, the attribute configuration information of a display accessory of the electronic device may be obtained, and the drive control parameter of the under-screen camera may be configured based on the attribute configuration information and the configuration data.

In embodiments of the present disclosure, on the basis of obtaining the attribute information, the attribute configuration information of the display accessory of the electronic device may also be obtained, and the drive control parameter of the under-screen camera may be configured by combining the attribute configuration information and the configuration data included in the attribute information. Exemplarily, the display accessories may include an anti-peek film, a tempered film and the like. At this point, the display accessories may also affect the image-forming results. The attribute configuration information of the display accessories may be combined to determine final drive control parameters, which may improve the image-forming quality. The attribute information of the display accessories may include the transmittance, reflectivity and the like of the display accessories.

Exemplarily, in response to that the tempered film is attached to the display screen, the tempered film itself may transmittance, such that the transmittance of the display screen attached with the tempered film may be reduced due to the tempered film. At this point, the color saturation in the drive control parameter may need to be increased to meet current scenario.

In above-mentioned embodiments of the present disclosure, the drive control parameters may be different for different users, different usage scenarios and different display accessories, the drive control parameters of the under-screen camera may be configured by combining one or more of the user profile information, device information and the attribute configuration information of the display accessories, such that configured drive control parameters may be more suitable for current scenario.

In some embodiments, after executing “configuring the drive control parameter of the under-screen camera” in above-mentioned exemplary step S402, as shown in FIG. 13, the electronic device may further include at least one of following exemplary steps S1301 to S1302.

At S1301, the usage duration and/or pixel aging data of the display screen may be monitored, and the drive control parameter of the under-screen camera may be updated at a determined interval duration based on the usage duration and/or pixel aging data.

In embodiments of the present disclosure, the interval duration may be configured based on the usage duration and/or pixel aging data of the display screen.

In embodiments of the present disclosure, the usage duration or pixel aging degree of the display screen may affect the transmittance of the first display region, such that the drive control parameter of the camera may be updated based on current transmittance estimation data after a specified interval duration.

Exemplarily, the display screen may turn yellow or dark during use, it may indicate that the display screen may have pixel aging which results in a low transmittance of the first display region. Therefore, the color saturation and brightness in the drive control parameter may be increased based on the pixel aging degree, thereby ensuring that the drive control parameter of the under-screen camera is matched with current display screen.

Exemplarily, in response to that the display screen is used for a long time, the display screen may be worn, which may affect the transmittance of the display screen. Therefore, the contrast and brightness in the drive control parameter may be increased based on the degree of wear, thereby ensuring that the drive control parameter of the under-screen camera is matched with current display screen.

At S1302, the environmental change data of the space environment where the electronic device is located may be obtained, and the drive control parameter of the under-screen camera may be updated based on the environmental change data.

In embodiments of the present disclosure, the environmental change data may include scene change data such as ambient brightness, background, outdoor or indoor and/or the like. The electronic device may obtain the environmental change data of the space environment where the electronic device is located and update the drive control parameter of the under-screen camera based on the environmental change data, such that updated drive control parameter may be more suitable for current use environment.

Exemplarily, in response to that the space where current electronic device is located is outdoor, since the outdoor light is stronger than the indoor light, different drive control parameters may be configured for outdoor or indoor. In response to that the brightness value in the drive control parameter is k, the brightness of the drive control parameter may be configured to a value less than k for the outdoor with strong light, and the brightness of the drive control parameter may be configured to a value higher than k for the indoor with weak light. Obviously, environmental data may also be considered comprehensively. For example, although the electronic device is at indoor, the ambient brightness may be high; and at this point, the ambient brightness must also be considered when the brightness value of the drive control parameter is configured.

In above-mentioned embodiments of the present disclosure, the changes during the operating process may be used to timely update the drive control parameter of the under-screen camera, thereby performing image acquisition based on timely updated drive control parameter to improve the image-forming quality.

Above-mentioned executable exemplary steps of “configuring the drive control parameter of the under-screen camera based on the attribute information” in exemplary step S402 may be combined or coexist, which may refer to exemplary steps S601 to S603, exemplary steps S701 to S703, and exemplary steps S1201 to S1203.

An exemplary implementation manner of the control method is described herein. When the user of the electronic device turns on the electronic device for the first time, the electronic device may read the transmittance data of the first display region from the driver chip of the display screen, including the red transmittance A %, the green transmittance B %, the deviation of the red transmittance and the green transmittance C %; based on the transmittance data, find the L1 group that the red transmittance A %, the green transmittance B %, and the deviation of the red transmittance and the green transmittance C % belong to, from the mapping relationship table (see Table 1) stored in the memory of the display screen, and obtain corresponding drive control logic A; load and run the drive control logic A to complete the image acquisition operation of the target framing object to obtain the target image; determine the difference (e.g., difference data) between the first image parameter of the target image and the target image parameter; when the difference is within the second threshold range, determine whether there is an image acquisition need at this point; in response to that there is no image acquisition need, terminate the configuration process; and in response to that there is an image acquisition need, directly run matched corresponding drive control logic A to perform image acquisition. In addition, when the user of the electronic device uses the electronic device for a long time, the user profile information, pixel aging data or other environmental change information may also be obtained to update the drive control logic.

Another exemplary implementation manner of the control method is described herein. When the user of the electronic device uses the under-screen camera for image acquisition, video recording or video calling for the first time, the electronic device may call the display controller of the electronic device to display the first identification code of the display screen stored in the memory on the display screen, and then call the virtual camera to identify the first identification code displayed on the display screen to obtain corresponding preset test data including the front light source brightness, the number of liquid crystal molecules and the pixel size; determine the transmittance data based on the preset test data including the front light source brightness, the number of liquid crystal molecules and the pixel size; based on the transmittance, determine corresponding drive compensation parameter of the under-screen camera, including the brightness gain, saturation or exposure time; adjust the preset drive control parameter using determined brightness gain, saturation or exposure time to obtain updated drive control parameter; and use the under-screen camera to acquire images, record videos or make video calls based on updated drive control parameter.

Embodiments of the present disclosure provide a control method. The control method may include obtaining attribute information of the display screen of the electronic device, where the attribute information may at least include the configuration data of the first display region of the display screen, and the first display region may be the display region corresponding to the under-screen camera of the electronic device; and configuring the drive control parameter of the under-screen camera based on the attribute information, thereby controlling the under-screen camera to complete the image acquisition operation based on the drive control parameter when the image-forming instruction is obtained. For the control method provided by the present disclosure, the attribute information of the display screen may be obtained to configure the drive control parameter, such that the image acquisition operation may be completed based on the drive control parameter during the image-forming process, and the display screen and the camera drive control parameter may be accurately matched with each other, thereby improving the image-forming quality.

Embodiments of the present disclosure provide a control apparatus 14. As shown in FIG. 14, the control apparatus 14 may include an acquisition module 1401, configured to obtain the attribute information of the display screen of the electronic device, where the attribute information may at least include the configuration data of the first display region of the display screen, and the first display region may be the display region corresponding to the under-screen camera of the electronic device; and a configuration module 1402, configured to set the drive control parameter of the under-screen camera based on the attribute information to control the under-screen camera to complete the image acquisition operation based on the drive control parameter when the image-forming instruction is obtained.

In embodiments of the present disclosure, the acquisition module 1401 may be further configured to, when the electronic device is turned on for the first time or assembly of the electronic device is completed, read the transmittance data of the first display region from a display controller of the display screen or the preset test data capable of being configured to calculate the transmittance of the first display region; when the electronic device is turned on for the first time or assembly of the electronic device is completed, output the first identification code on the display screen, and identify the first identification code to obtain the transmittance data of the first display region carried by the first identification code or the preset test data capable of being configured to calculate the transmittance of the first display region; when the under-screen camera is called for the first time, read the transmittance data of the first display region or the preset test data capable of being configured to calculate the transmittance of the first display region from the display controller of the display screen; and when the under-screen camera is called for the first time, display and output the first identification code on the display screen, and identity the first identification code by using and calling the application of the under-screen camera to obtain the transmittance data of the first display region carried by the first identification code or the preset test data capable of being configured to calculate the transmittance of the first display region.

In embodiments of the present disclosure, the configuration module 1402 may be further configured to determine the drive compensation parameter of the under-screen camera based on the configuration data of the first display region, and update the preset drive control parameter of the under-screen camera based on the drive compensation parameter; based on the configuration data of the first display region, control the under-screen camera to load and run the drive control logic matching the configuration data from a target memory, where the drive control logic may include the drive control parameter needed to control the under-screen camera to perform image acquisition operations; and based on the configuration data of the first display region, write firmware data matching the configuration data to the controller of the under-screen camera, such that the under-screen camera may run the firmware data to perform image acquisition operations.

In embodiments of the present disclosure, the configuration module 1402 may be further configured to, in response to that the electronic device is turned on for the first time, determine the drive compensation parameter of the under-screen camera based on obtained transmittance data of the first display region or the preset test data, thereby updating the preset drive control parameter of the under-screen camera based on the drive compensation parameter, or load and run the matched drive control logic from the target memory based on obtained transmittance data of the first display region or the preset test data; in response to that the under-screen camera is called for the first time, determine the drive compensation parameter of the under-screen camera based on the obtained transmittance data of the first display region or the preset test data, update the preset drive control parameter of the under-screen camera based on the drive compensation parameter, and complete the image acquisition operation based on updated drive control parameter; and in response to that the under-screen camera is called for the first time, load and run the matching drive control logic from the target memory based on obtained transmittance data of the first display region or the preset test data, and perform corresponding image acquisition operation based on the drive control logic.

In embodiments of the present disclosure, the acquisition module 1401 may be further configured to output the first prompt message when the transmittance of the first display region of the display screen characterized by the attribute information is within the first threshold range; and the configuration module 1402 may be further configured to verify the image-forming quality of the under-screen camera after completing the configuration operation of the drive control parameter of the under-screen camera.

In embodiments of the present disclosure, the configuration module 1402 may be further configured to control the under-screen camera to complete the image acquisition operation of the target framing object based on the drive control parameter to obtain the target image; when the difference (e.g., difference data) between the first image parameter of the target image and the target image parameter is within the second threshold range, output the second prompt message that the under-screen camera has passed the image-forming quality verification; and when the difference (e.g., difference data) between the first image parameter of the target image and the target image parameter is within the third threshold range, adjust the drive control parameter of the under-screen camera based on the difference data or output the third prompt message.

In embodiments of the present disclosure, the configuration module 1402 may be further configured to obtain the user profile information of the user of the electronic device, and configure the drive control parameter of the under-screen camera based on the user profile information and the configuration data; obtain the device information of the electronic device, configure the drive control parameter of the under-screen camera based on the device information and the configuration data; and obtain the attribute configuration information of the display accessory of the electronic device, and configure the drive control parameter of the under-screen camera based on the attribute configuration information and the configuration data.

In embodiments of the present disclosure, the configuration module 1402 may be further configured to monitor the usage duration and/or pixel aging data of the display screen, and update the drive control parameter of the under-screen camera at a determined interval based on the usage duration and/or pixel aging data; and obtain environmental change data of the space environment in which the electronic device is located, and update the drive control parameter of the under-screen camera based on the environmental change data.

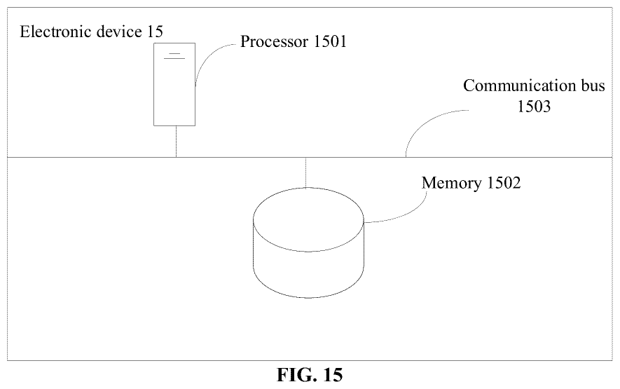

Embodiments of the present disclosure provide a data processing device 15. As shown in FIG. 15, the data processing device 15 may include a processor 1501, a memory 1502 and a communication bus 1503.

The communication bus 1503 may be configured to implement the communication connection between the processor 1501 and the memory 1502.

The processor 1501 may be configured to execute the computer program stored in the memory 1502 to implement above-mentioned control method.

Various embodiments of the present disclosure provide an electronic device. The attribute information of the display screen of the electronic device may be obtained, where the attribute information may at least include the configuration data of the first display region of the display screen, and the first display region may be the display region corresponding to the under-screen camera of the electronic device; and the drive control parameter of the under-screen camera may be configured based on the attribute information, thereby controlling the under-screen camera to complete the image acquisition operation based on the drive control parameter when the image-forming instruction is obtained. For the electronic device provided by the present disclosure, the attribute information of the display screen may be obtained to configure the drive control parameter, such that the image acquisition operation may be completed based on the drive control parameter during the image-forming process, and the display screen and the camera drive control parameter may be accurately matched with each other, thereby improving the image-forming quality.

Various embodiments of the present disclosure provide a computer-readable storage medium, which may store one or more computer programs. The one or more computer programs may be executed by one or more processors to implement above-mentioned control method. The computer-readable storage medium may be a volatile memory including a random access memory (RAM), or a non-volatile memory including a read-only memory (ROM), a flash memory, a hard disk drive (HDD) or a solid-state drive (SSD); or may be a respective device including one or any combination of above-mentioned memories, such as a mobile phone, a computer, a tablet device, a personal digital assistant or the like.

Various embodiments of the present disclosure provide an electronic device. The electronic device includes a memory, configured to store a computer program; and one or more processors, configured to, when the computer program is executed, perform a control method. The control method includes obtaining attribute information of a display screen of an electronic device, where the attribute information at least includes configuration data of a first display region of the display screen, and the first display region is a display region corresponding to an under-screen camera of the electronic device; and configuring a drive control parameter of the under-screen camera based on the attribute information, thereby controlling the under-screen camera to complete an image acquisition operation based on the drive control parameter when an image-forming instruction is obtained.

It should be understood by those skilled in the art that embodiments of the present disclosure may be provided as methods, systems, or computer program products. Therefore, the present disclosure may take the form of hardware embodiments, software embodiments, or embodiments combining software and hardware. Moreover, the present disclosure may take the form of a computer program product implemented on one or more computer-usable storage media (including but not limited to disk storage and optical storage and the like) containing computer-usable program codes.

The present disclosure is described with reference to the flowcharts and/or block diagrams of the methods, apparatuses, devices (systems), and computer program products according to embodiments of the present disclosure. It may be understood that each process and/or box in the flowchart and/or block diagram, as well as the combination of processes and/or boxes in the flowchart and/or block diagram, may be implemented by computer program instructions. The computer program instructions may be provided to processors of a general-purpose computer, a special-purpose computer, an embedded processor, or other programmable data processing device to produce a machine. In such way, the instructions executed by the processor of the computer or other programmable data processing device may generate an apparatus for implementing functions specified in one or more processes in the flowchart and/or one or more boxes in the block diagram.

The computer program instructions may also be stored in a computer-readable memory that may guide a computer or other programmable data processing device to work in certain manner, such that the instructions stored in the computer-readable memory may generate a product including an instruction apparatus that implements functions specified in one or more processes of the flowchart and/or one or more boxes of the block diagram.

The computer program instructions may also be loaded onto a computer or other programmable data processing device, such that a series of exemplary operation steps may be performed on the computer or other programmable device to generate computer-implemented processing. Therefore, the instructions executed on the computer or other programmable device may provide exemplary steps for implementing functions specified in one or more processes of the flowchart and/or one or more boxes of the block diagram.

The above may be merely certain implementation manners of the present disclosure, which may not limit the protection scope of the present disclosure. Any changes or substitutions that may be easily thought of by a person skilled in the art within the technical scope disclosed in the present disclosure should be included in the protection scope of the present disclosure. Therefore, the protection scope of the present disclosure shall be based on the protection scope of the claims.

What is claimed is:

1. A control method, comprising:
obtaining attribute information of a display screen of an electronic device, wherein the attribute information at least includes configuration data of a first display region of the display screen, and the first display region is a display region corresponding to an under-screen camera of the electronic device; and
configuring a drive control parameter of the under-screen camera based on the attribute information, thereby controlling the under-screen camera to complete an image acquisition operation based on the drive control parameter when an image-forming instruction is obtained.

2. The method according to claim 1, wherein obtaining the attribute information of the display screen of the electronic device includes at least one of following:
when the electronic device is turned on for a first time or assembly of the electronic device is completed, reading transmittance data of the first display region or preset test data, capable of being configured to calculate transmittance of the first display region, from a display controller of the display screen;
when the electronic device is turned on for the first time or the assembly of the electronic device is completed, displaying and outputting a first identification code on the display screen, and identifying the first identification code to obtain the transmittance data of the first display region carried by the first identification code or the preset test data capable of being configured to calculate the transmittance of the first display region;
when the under-screen camera is called for a first time, reading the transmittance data of the first display region or the preset test data, capable of being configured to calculate the transmittance of the first display region, from the display controller of the display screen; or
when the under-screen camera is called for the first time, displaying and outputting the first identification code on the display screen, and identifying the first identification code by calling an application of the under-screen camera to obtain the transmittance data of the first display region carried by the first identification code or the preset test data capable of being configured to calculate the transmittance of the first display region.

3. The method according to claim 1, wherein configuring the drive control parameter of the under-screen camera based on the attribute information includes at least one of following:
determining a drive compensation parameter of the under-screen camera based on the configuration data of the first display region, and updating a preset drive control parameter of the under-screen camera based on the drive compensation parameter;
based on the configuration data of the first display region, controlling the under-screen camera to load and run a drive control logic matching the configuration data from a target memory, wherein the drive control logic includes a drive control parameter needed to control the under-screen camera to perform the image acquisition operation; or
based on the configuration data of the first display region, writing firmware data matching the configuration data to a controller of the under-screen camera, such that the under-screen camera runs the firmware data to perform the image acquisition operation.

4. The method according to claim 3, wherein configuring the drive control parameter of the under-screen camera based on the attribute information includes at least one of following:
in response to that the electronic device is turned on for a first time, determining the drive compensation parameter of the under-screen camera based on obtained transmittance data of the first display region or preset test data, thereby updating the preset drive control parameter of the under-screen camera based on the drive compensation parameter; or based on obtained transmittance data of the first display region or the preset test data, loading and running the drive control logic matching the configuration data from the target memory;
in response to that the under-screen camera is called for a first time, determining the drive compensation parameter of the under-screen camera based on obtained transmittance data of the first display region or the preset test data; based on the drive compensation parameter, updating the preset drive control parameter of the under-screen camera; and completing the image acquisition operation based on updated drive control parameter; or
in response to that the under-screen camera is called for the first time, loading and running the drive control logic matching the configuration data from the target memory based on obtained transmittance data of the first display region or the preset test data, and performing a corresponding image acquisition operation based on the drive control logic.

5. The method according to claim 1, further including at least one of following:
when transmittance of the first display region of the display screen characterized by the attribute information is within a first threshold range, outputting a first prompt message; or
after completing a configuration operation of the drive control parameter of the under-screen camera, verifying image-forming quality of the under-screen camera.

6. The method according to claim 5, wherein verifying the image-forming quality of the under-screen camera further includes at least one of following:
based on the drive control parameter, controlling the under-screen camera to complete the image acquisition operation of the target framing object to obtain a target image;
when a difference between a first image parameter of the target image and a target image parameter is within a second threshold range, outputting a second prompt message that the under-screen camera passes image-forming quality verification; or
when the difference between the first image parameter of the target image and the target image parameter is within a third threshold range, adjusting the drive control parameter of the under-screen camera or outputting a third prompt message based on the difference between the first image parameter of the target image and the target image parameter.

7. The method according to claim 1, wherein configuring the drive control parameter of the under-screen camera based on the attribute information further includes at least one of following:
obtaining user profile information of a user of the electronic device and configuring the drive control parameter of the under-screen camera based on the user profile information and the configuration data;
obtaining device information of the electronic device and configuring the drive control parameter of the under-screen camera based on the device information and the configuration data; or
obtaining attribute configuration information of a display accessory of the electronic device and configuring the drive control parameter of the under-screen camera based on the attribute configuration information and the configuration data.

8. The method according to claim 1, after configuring the drive control parameter of the under-screen camera based on the attribute information, further including at least one of following:
monitoring a usage duration and/or pixel aging data of the display screen, and updating the drive control parameter of the under-screen camera at a determined interval based on the usage duration and/or the pixel aging data; or
obtaining environmental change data of a space environment where the electronic device is located, and updating the drive control parameter of the under-screen camera based on the environmental change data.

9. An electronic device, comprising:
a memory, configured to store a computer program; and
one or more processors, configured to, when the computer program is executed, perform:
obtaining attribute information of a display screen of an electronic device, wherein the attribute information at least includes configuration data of a first display region of the display screen, and the first display region is a display region corresponding to an under-screen camera of the electronic device; and
configuring a drive control parameter of the under-screen camera based on the attribute information, thereby controlling the under-screen camera to complete an image acquisition operation based on the drive control parameter when an image-forming instruction is obtained.

10. The electronic device according to claim 9, wherein for obtaining the attribute information of the display screen of the electronic device, the one or more processors are configured to perform at least one of following:
when the electronic device is turned on for a first time or assembly of the electronic device is completed, reading transmittance data of the first display region or preset test data, capable of being configured to calculate transmittance of the first display region, from a display controller of the display screen;
when the electronic device is turned on for the first time or the assembly of the electronic device is completed, displaying and outputting a first identification code on the display screen, and identifying the first identification code to obtain the transmittance data of the first display region carried by the first identification code or the preset test data capable of being configured to calculate the transmittance of the first display region;
when the under-screen camera is called for a first time, reading the transmittance data of the first display region or the preset test data, capable of being configured to calculate the transmittance of the first display region, from the display controller of the display screen; or
when the under-screen camera is called for the first time, displaying and outputting the first identification code on the display screen, and identifying the first identification code by calling an application of the under-screen camera to obtain the transmittance data of the first display region carried by the first identification code or the preset test data capable of being configured to calculate the transmittance of the first display region.

11. The electronic device according to claim 9, wherein for configuring the drive control parameter of the under-screen camera based on the attribute information, the one or more processors are configured to perform at least one of following:
determining a drive compensation parameter of the under-screen camera based on the configuration data of the first display region, and updating a preset drive control parameter of the under-screen camera based on the drive compensation parameter;
based on the configuration data of the first display region, controlling the under-screen camera to load and run a drive control logic matching the configuration data from a target memory, wherein the drive control logic includes a drive control parameter needed to control the under-screen camera to perform the image acquisition operation; or
based on the configuration data of the first display region, writing firmware data matching the configuration data to a controller of the under-screen camera, such that the under-screen camera runs the firmware data to perform the image acquisition operation.

12. The electronic device according to claim 11, wherein for configuring the drive control parameter of the under-screen camera based on the attribute information, the one or more processors are configured to perform at least one of following:
in response to that the electronic device is turned on for a first time, determining the drive compensation parameter of the under-screen camera based on obtained transmittance data of the first display region or preset test data, thereby updating the preset drive control parameter of the under-screen camera based on the drive compensation parameter; or based on obtained transmittance data of the first display region or the preset test data, loading and running the drive control logic matching the configuration data from the target memory;
in response to that the under-screen camera is called for a first time, determining the drive compensation parameter of the under-screen camera based on obtained transmittance data of the first display region or the preset test data; based on the drive compensation parameter, updating the preset drive control parameter of the under-screen camera; and completing the image acquisition operation based on updated drive control parameter; or
in response to that the under-screen camera is called for the first time, loading and running the drive control logic matching the configuration data from the target memory based on obtained transmittance data of the first display region or the preset test data, and performing a corresponding image acquisition operation based on the drive control logic.

13. The electronic device according to claim 9, wherein the one or more processors are configured to perform at least one of following:
when transmittance of the first display region of the display screen characterized by the attribute information is within a first threshold range, outputting a first prompt message; or
after completing a configuration operation of the drive control parameter of the under-screen camera, verifying image-forming quality of the under-screen camera.

14. The electronic device according to claim 13, wherein for verifying the image-forming quality of the under-screen camera further, the one or more processors are configured to perform at least one of following:
based on the drive control parameter, controlling the under-screen camera to complete the image acquisition operation of the target framing object to obtain a target image;
when a difference between a first image parameter of the target image and a target image parameter is within a second threshold range, outputting a second prompt message that the under-screen camera passes image-forming quality verification; or
when the difference between the first image parameter of the target image and the target image parameter is within a third threshold range, adjusting the drive control parameter of the under-screen camera or outputting a third prompt message based on the difference between the first image parameter of the target image and the target image parameter.

15. The electronic device according to claim 9, wherein for configuring the drive control parameter of the under-screen camera based on the attribute information, the one or more processors are further configured to perform at least one of following:
obtaining user profile information of a user of the electronic device and configuring the drive control parameter of the under-screen camera based on the user profile information and the configuration data;
obtaining device information of the electronic device and configuring the drive control parameter of the under-screen camera based on the device information and the configuration data; or
obtaining attribute configuration information of a display accessory of the electronic device and configuring the drive control parameter of the under-screen camera based on the attribute configuration information and the configuration data.

16. The electronic device according to claim 9, wherein after configuring the drive control parameter of the under-screen camera based on the attribute information, the one or more processors are further configured to perform at least one of following:
monitoring a usage duration and/or pixel aging data of the display screen, and updating the drive control parameter of the under-screen camera at a determined interval based on the usage duration and/or the pixel aging data; or
obtaining environmental change data of a space environment where the electronic device is located, and updating the drive control parameter of the under-screen camera based on the environmental change data.

17. A non-transitory computer-readable storage medium containing a computer program that, when being executed, causes one or more processors to perform:
obtaining attribute information of a display screen of an electronic device, wherein the attribute information at least includes configuration data of a first display region of the display screen, and the first display region is a display region corresponding to an under-screen camera of the electronic device; and
configuring a drive control parameter of the under-screen camera based on the attribute information, thereby controlling the under-screen camera to complete an image acquisition operation based on the drive control parameter when an image-forming instruction is obtained.

18. The storage medium according to claim 17, wherein for obtaining the attribute information of the display screen of the electronic device, the one or more processors are configured to perform at least one of following:
when the electronic device is turned on for a first time or assembly of the electronic device is completed, reading transmittance data of the first display region or preset test data, capable of being configured to calculate transmittance of the first display region, from a display controller of the display screen;
when the electronic device is turned on for the first time or the assembly of the electronic device is completed, displaying and outputting a first identification code on the display screen, and identifying the first identification code to obtain the transmittance data of the first display region carried by the first identification code or the preset test data capable of being configured to calculate the transmittance of the first display region;
when the under-screen camera is called for a first time, reading the transmittance data of the first display region or the preset test data, capable of being configured to calculate the transmittance of the first display region, from the display controller of the display screen; or
when the under-screen camera is called for the first time, displaying and outputting the first identification code on the display screen, and identifying the first identification code by calling an application of the under-screen camera to obtain the transmittance data of the first display region carried by the first identification code or the preset test data capable of being configured to calculate the transmittance of the first display region.

19. The storage medium according to claim 17, wherein for configuring the drive control parameter of the under-screen camera based on the attribute information, the one or more processors are configured to perform at least one of following:
determining a drive compensation parameter of the under-screen camera based on the configuration data of the first display region, and updating a preset drive control parameter of the under-screen camera based on the drive compensation parameter;
based on the configuration data of the first display region, controlling the under-screen camera to load and run a drive control logic matching the configuration data from a target memory, wherein the drive control logic includes a drive control parameter needed to control the under-screen camera to perform the image acquisition operation; or
based on the configuration data of the first display region, writing firmware data matching the configuration data to a controller of the under-screen camera, such that the under-screen camera runs the firmware data to perform the image acquisition operation.

20. The storage medium according to claim 19, wherein for configuring the drive control parameter of the under-screen camera based on the attribute information, the one or more processors are configured to perform at least one of following:
in response to that the electronic device is turned on for a first time, determining the drive compensation parameter of the under-screen camera based on obtained transmittance data of the first display region or preset test data, thereby updating the preset drive control parameter of the under-screen camera based on the drive compensation parameter; or based on obtained transmittance data of the first display region or the preset test data, loading and running the drive control logic matching the configuration data from the target memory;
in response to that the under-screen camera is called for a first time, determining the drive compensation parameter of the under-screen camera based on obtained transmittance data of the first display region or the preset test data; based on the drive compensation parameter, updating the preset drive control parameter of the under-screen camera; and completing the image acquisition operation based on updated drive control parameter; or
in response to that the under-screen camera is called for the first time, loading and running the drive control logic matching the configuration data from the target memory based on obtained transmittance data of the first display region or the preset test data, and performing a corresponding image acquisition operation based on the drive control logic.
